(19) United States
(12) Patent Application Publication
(10) Pub. No.: US 2013/0135869 A1
(43) Pub. Date: May 30, 2013

(54) LUMINAIRE

(71) Applicant: Tsuyoshi OYAIZU, Yokosuka-shi (JP)

(72) Inventor: Tsuyoshi OYAIZU, Yokosuka-shi (JP)

(73) Assignee: Toshiba Lighting & Technology Corporation, Kanagawa (JP)

(21) Appl. No.: 13/592,879

(22) Filed: Aug. 23, 2012

(30) Foreign Application Priority Data
Nov. 30, 2011 (JP) 2011-262626

(51) Int. Cl. F21V 15/01; F21S 4/00

(52) U.S. Cl. 362/249.14; 362/249.01

(57) ABSTRACT

According to one embodiment, a luminaire includes an envelope including a light transmission section, a rectangular substrate provided in the envelope, and a pair of supporting sections. On one surface of the substrate, plural light-emitting elements are mounted side by side on a line shifted to one side in the width direction of the substrate from a center line extending along the longitudinal direction of the substrate. Electronic components are mounted in positions deviating to the other side in the width direction of the substrate from the line. The pair of supporting sections are provided on the inner surface of the envelope and support both the end sides of the substrate, which are along the longitudinal direction of the substrate.

### CROSS-REFERENCE TO RELATED APPLICATIONS

This application is based upon and claims the benefit of priority from Japanese Patent Application No. 2011-262626, filed Nov. 30, 2011, the entire contents of which are incorporated herein by reference.

### FIELD

Embodiments described herein relate generally to a luminaire in which a semiconductor light-emitting element such as an LED (light-emitting diode) is used as a light source.

### BACKGROUND

In recent years, as a straight tube type lamp of the next generation replacing an elongated straight tube type fluorescent lamp, a straight tube type LED lamp is being spread. In the straight tube type LED lamp, a light-emitting module on which plural LEDs (light-emitting diodes) are mounted side by side along the center line of an elongated band-shaped substrate is housed and arranged in a cylindrical straight tube having translucency.

If the light-emitting module having a band plate shape is attached in the cylindrical straight tube, for example, a module substrate is inserted from one end side of the straight tube along two rails extended on the inner surface of the straight tube. If this attaching method is adopted, work for positioning and fixing the substrate to the straight tube can be facilitated and work for attaching the module substrate can be facilitated.

If a flat light-emitting module having a band plate shape is attached in the cylindrical straight tube, an attachment position of the substrate substantially depends on the width of the substrate and the inner diameter of the straight tube. For example, if the width of the substrate is relatively large and substantially equal to the inner diameter of the straight tube, the substrate is attached to a position near the center of the straight tube. On the other hand, if the width of the substrate is smaller than the inner diameter of the straight tube, the substrate is attached to be displaced to a direction closer to the inner surface from the center of the straight tube.

In other words, in order to expand a luminous intensity distribution angle of light emitted from the light-emitting module, it is advantageous to reduce the width of the substrate as much as possible and bring the rear surface of the substrate close to the inner surface of the straight tube. However, if electronic components such as a capacitor are mounted other than the LEDs, there is a limit in narrowing the substrate.

Usually, the plural LEDs are mounted side by side along the center line in the longitudinal direction of the substrate. As explained above, the electronic components are mounted on the substrate. Therefore, in order to prevent a dark portion due to the electronic components from being formed in an LED array it is suitable to mount the electronic components in positions displaced to a substrate end side deviating from the LED array.

On the other hand, if the electronic components are mounted in the positions displaced to the substrate end side, in the case of a structure in which both the end sides of the substrate, which are along the longitudinal direction of the substrate, are held by, for example, rails, regions for holding both the end sides with the rails (regions where the electronic components may not be able to be mounted) are necessary at both the ends in the width direction of the substrate, which are along the longitudinal direction of the substrate. Therefore, it is difficult to reduce the width of the substrate.

Therefore, there is a demand for development of a luminaire that is easily assembled and can realize wide luminous intensity distribution.

### BRIEF DESCRIPTION OF THE DRAWINGS

FIG. 1 is an external perspective view of a luminaire according to an embodiment;

FIG. 2 is a sectional view of the luminaire shown in FIG. 1 taken along a line F2;

FIG. 3 is a circuit diagram of a circuit configuration of the luminaire shown in FIG. 1;

FIG. 4 is a plan view of a module array of light-emitting modules incorporated in a straight tube type lamp attached to the luminaire shown in FIG. 1, wherein the module array is viewed from a light extraction side;

FIG. 5 is an enlarged plan view of a light-emitting module closest to a power feeding side in the module array shown in FIG. 4;

FIG. 6 is an enlarged plan view of a light-emitting module arranged in the middle of the module array shown in FIG. 4;

FIG. 7 is an enlarged plan view of a light-emitting module most distant from the power feeding side in the module array shown in FIG. 4;

FIG. 8 is a wiring diagram of the module array shown in FIG. 4;

FIG. 9 is a sectional view of a light-emitting module taken along a line F9-F9 shown in FIG. 5;

FIG. 10 is a plan view of pads, on which a light-emitting element shown in FIG. 9 is mounted, viewed from the light extraction side; and

FIG. 11 is a plan view of a state in which the light-emitting element is provided on the pads shown in FIG. 10.

### DETAILED DESCRIPTION

In general, according to one embodiment, a luminaire includes an envelope including a light transmission section, a rectangular substrate provided in the envelope, and a pair of supporting sections. On one surface of the substrate, a plurality of light-emitting elements are mounted side by side on a line shifted to one side in the width direction from the center line extending along the longitudinal direction of the substrate. Electronic components are mounted in positions deviating to the other side in the width direction of the substrate from the line. The pair of supporting sections are provided on the inner surface of the envelope and configured to support both the end sides of the substrate, which are along the longitudinal direction of the substrate.

Various embodiments will be described hereinafter with reference to the accompanying drawings.

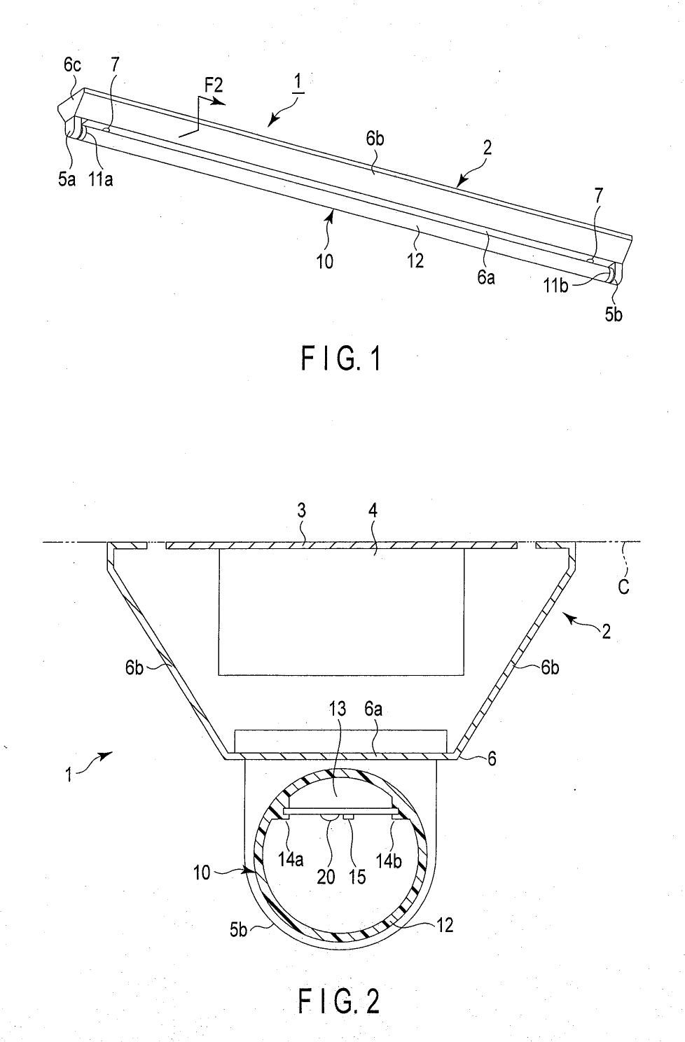

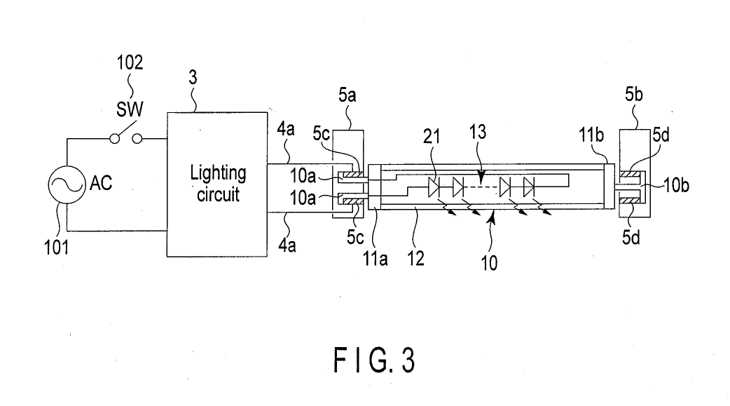

FIG. 1 is an external perspective view of a luminaire 1 according to an embodiment. FIG. 2 is a sectional view of the luminaire 1. FIG. 3 is a wiring diagram of a circuit configuration of the luminaire 1. The luminaire 1 includes a luminaire main body 2 (hereinafter simply referred to as main body 2) fixed to a ceiling C of a building and a straight tube type lamp 10 (hereinafter simply referred to as lamp 10) detachably attached to the main body 2.

As shown in FIGS. 1 and 2, the main body 2 includes an elongated band-shaped base plate 3 fixed to the ceiling C using not-shown screws or the like, a lighting circuit 4 attached to the center in the longitudinal direction of the base plate 3, a pair of sockets 5a and 5b attached to both the ends in the longitudinal direction of the base plate 3, and a reflector 6 provided on the front surface side of the base plate 3 to cover the lighting circuit 4 and other not-shown components.

The base plate 3 is a rectangular band-shaped metal plate extending substantially in parallel to a tube axis of the lamp 10. A not-shown power-supply terminal table for connecting a not-shown power-supply line drawn in from an attic, not-shown supporting members for attaching the pair of sockets 5a and 5b, not-shown supporting metal fittings for fastening and fixing the reflector 6, and the like are attached to the base plate 3. The power-supply terminal table is connected to the lighting circuit 4 via a not-shown wire.

As shown in FIG. 3, the lighting circuit 4 converts an alternating current input from a commercial alternating-current power supply 101 via the power-supply line connected to the power-supply terminal stand into a direct current. The pair of sockets 5a and 5b respectively include terminal metal fittings 5c and 5d set in contact with pins 10a and 10b present at both the ends in the longitudinal direction of the lamp 10. The lighting circuit 4 is connected to the terminal metal fitting 5c of one socket 5a via a wire 4a. The lighting circuit 4 feeds the direct current to one end of the lamp 10 via the one socket 5a. The pin 10b present at the other end of the lamp 10 is simply supported by the other socket 5b and is not electrically connected.

The pair of sockets 5a and 5b are adapted to caps 11a and 11b of a 13G type present at both the ends of the lamp 10. The lamp 10 is attached by inserting the pins 10a and 10b at both the ends of the lamp 10 into the sockets 5a and 5b and rotating the lamp 10. In this state, power feeding from the main body 2 to the lamp 10 can be performed. In other words, it is possible to easily remove the lamp 10 from the luminaire main body 2 by rotating the lamp 10.

As indicated by a cross section shown in FIG. 2, the reflector 6 includes a rectangular band-shaped bottom plate section 6a extending substantially in parallel to the base plate 3 in a position separated downward from the base plate 3 and a pair of rectangular band-shaped side plate sections 6b inclining to spread from both the end sides of the bottom plate section 6a, which are along the longitudinal direction of the bottom plate section 6a, to the outer side of both the end sides of the base plate 3, which are along the longitudinal direction of the base plate 3. End sides of the pair of side plate sections 6b extending to the ceiling C are bent to the inner side toward the end sides of the base plate 3. In this embodiment, the pair of side plate sections 6b and the bottom plate section 6a are integrally formed by bending one metal plate.

Holes through which the sockets 5a and 5b are inserted are provided at both the ends in the longitudinal direction of the bottom plate section 6a. A pair of end plate sections 6c are provided at both the ends in the longitudinal direction of the bottom plate section 6a and the pair of side plate sections 6b. The pair of end plate sections 6c are provided to close both the ends in the longitudinal direction of a space surrounded by the bottom plate section 6a, the pair of side plate sections 6b, and the base plate 3.

The surfaces of the bottom plate section 6a and the pair of side plate sections 6b are formed of a white color steel plate. Therefore, the surface of the bottom plate section 6a and the surfaces of the pair of side plate sections 6b function as satisfactory reflection surfaces for light. The reflector 6 is fastened and fixed by screwing decoration screws 7 into the not-shown supporting metal fittings of the base plate 3. The pair of sockets 5a and 5b project in a direction (downward in the figure) away from the base plate 3 via the holes present at both the ends in the longitudinal direction of the bottom plate section 6a.

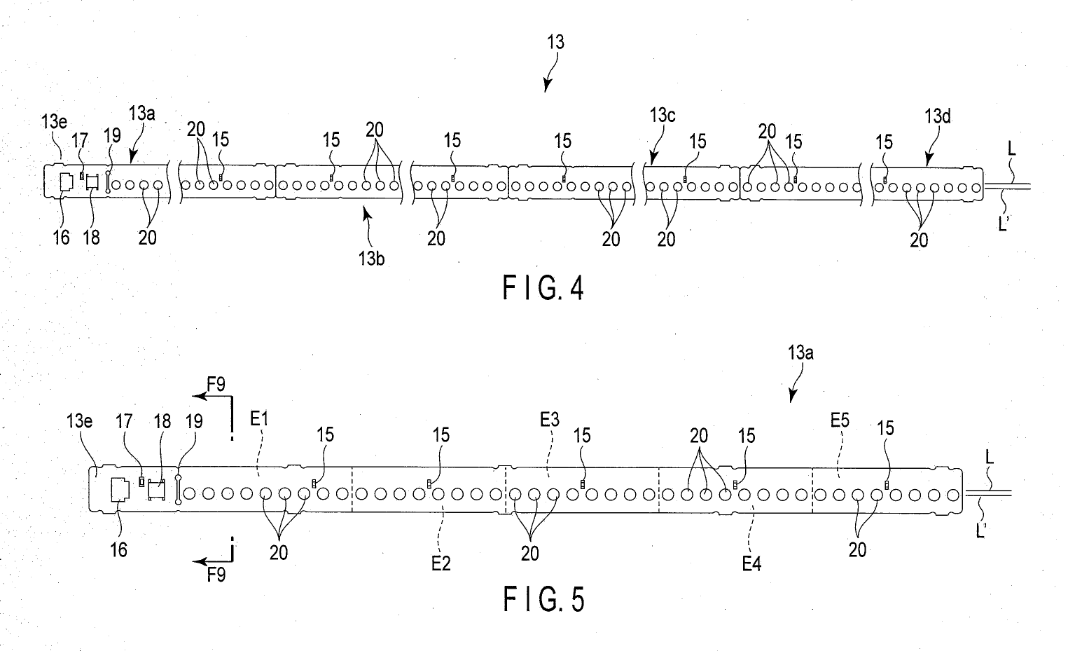

The lamp 10 includes an elongated cylindrical straight tube 12 (an envelope) formed of translucent resin, the pair of caps 11a and 11b attached to both the ends in the longitudinal direction of the straight tube 12, and four light-emitting modules 13a to 13d. The light-emitting modules 13a, 13b, 13c, and 13d are housed and arranged in the straight tube 12 side by side in this order from the cap 11a on the power feeding side to the other cap 11b. In the following explanation, as shown in FIG. 4, a structure in which the four light-emitting modules 13a to 13d are connected in a row in the order of insertion is referred to as a module array 13.

In a state in which the lamp 10 is attached to the main body 2 as shown in FIGS. 1 and 2, when a switch 102 shown in FIG. 3 is turned on, a most part of light emitted from the lamp 10 travels downward in the figure (to a light extraction side). A part of the light traveling in the opposite direction, i.e., to the ceiling C is reflected by the bottom plate section 6a and the pair of side plate sections 6b of the reflector 6. In other words, the luminaire 1 according to this embodiment can emit light in all the direction for illuminating the entire room including the ceiling C in addition to light for directly illuminating the inside of the room.

The straight tube 12 of the lamp 10 is desirably formed of polycarbonate resin mixed with a light diffusing material. The straight tube 12 only has to be a structure including at least a light transmission section in a light emitting direction. The diffuse transmittance of the light transmission section of the straight tube 12 is desirably 90% to 95%. On the inner surface of the straight tube 12, two rails 14a and 14b for sliding and guiding the four light-emitting modules 13a to 13d and positioning and arranging the four light-emitting modules 13a to 13d in predetermined positions in the straight tube 12 are protrudingly provided. The rails 14a and 14b are continuously or discontinuously extended straight along the tube axis.

The four light-emitting modules 13a to 13d are inserted through from one end side of the straight tube 12 in a state in which the four light-emitting modules 13a to 13d are coupled to be elongated in advance (a state of the module array 13) as shown in FIG. 4. Both the end sides of the four light-emitting modules 13a to 13d, which are along the longitudinal direction of the four light-emitting modules 13a to 13d, are guided by the pair of rails 14a and 14b (a pair of supporting sections). The four light-emitting modules 13a to 13d are inserted into and arranged in the straight tube 12. The module array 13 is inserted through and arranged in the straight tube 12 along the rails 14a and 14b in this way, whereby assembly of the lamp 10 can be facilitated.

If the flat module array 13 having a band plate shape is attached on the inside of the cylindrical straight tube 12, an attachment position of the module array 13 substantially depends on the width in a direction orthogonal to the longitudinal direction of the module array 13 and the inner diameter of the straight tube 12. In other words, by reducing the width of the module array 13, the module array 13 can be attached in a position further apart from the center of the tube axis. This is advantageous for a wide luminous intensity distribution of the lamp 10.

On the other hand, if the width of the module array 13 is simply reduced, mounting spaces for the light-emitting elements and the electronic components are narrowed. In particular, if the structure in which both the ends in the width direction of the module array 13 are supported by the rails 14a and 14b is adopted as in this embodiment, regions for supporting the module array 13 with the rails 14a and 14b are necessary at both the ends in the width direction of the module array 13. The electronic components may not be able to be mounted in the regions.

Therefore, in this embodiment, the structure in which the rails 14a and 14b are protrudingly provided in the straight tube 12 is adopted to make it possible to realize the wide luminous intensity distribution of the lamp 10 while facilitating attachment of the light-emitting modules 13a to 13d. A detailed structure of the light-emitting modules 13a to 13d (the module array 13), which can be reduced in width, is explained mainly with reference to FIGS. 4 to 11.

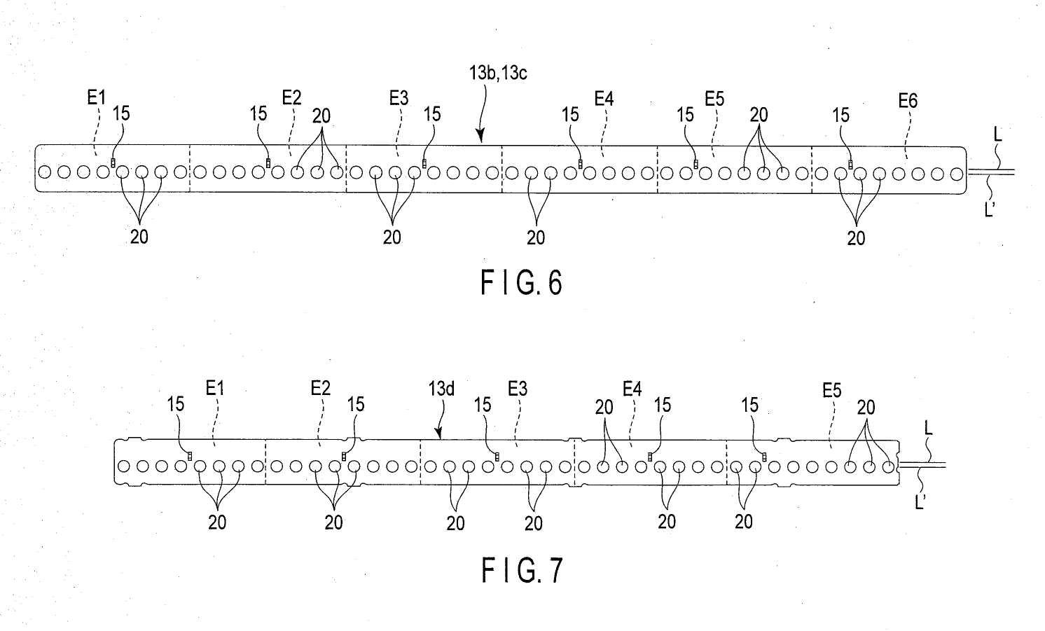

FIG. 4 is a plan view of the module array 13 viewed from the light extraction side. FIG. 5 is an enlarged plan view of the light-emitting module 13a closest to the power feeding side among the four light-emitting modules 13a to 13d. FIG. 6 is an enlarged plan view of the two light-emitting modules 13b and 13c having the same shape present in the middle among the four light-emitting modules 13a to 13d. FIG. 7 is an enlarged plan view of the light-emitting module 13d most distant from the power feeding side among the four light-emitting modules 13a to 13d.

As a characteristic of the light-emitting modules 13a to 13d shown in FIGS. 5 to 7 and the module array 13 shown in FIG. 4 in which the light-emitting modules 13a to 13d are connected in a row, a layout is adopted in which the centers of plural light-emitting elements 20 are offset to lie side by side on an imaginary line L′ displaced to one side in the width direction (the lower side in the figure) from a center line L of module substrates. Further, according to the layout, plural capacitors 15 (electronic components) are mounted in positions deviating to the other side in the width direction (the upper side in the figure) from the line L′ on which the plural light-emitting elements 20 are mounted. Since such a component mounting layout is adopted, it is possible to reduce the width of the module substrates while securing, at both the ends in the width direction of the module array 13, non-mounting spaces where the substrates are supported by the rails 14a and 14b.

Each of the light-emitting module 13a (FIG. 5) and the light-emitting module 13d (FIG. 7) present at both the ends in the longitudinal direction of the module array 13 includes five substrate regions E1 to E5 along the longitudinal direction. Each of the light-emitting modules 13b and 13c (FIG. 6) present in the middle of the module array 13 includes six substrate regions E1 to E6 along the longitudinal direction. The light-emitting module 13a closest to the power feeding side has a structure substantially the same as the light-emitting module 13d most distant from the power feeding side except that the light-emitting module 13a includes a component mounting region 13e in the substrate region E1 closest to the power feeding side.

The light-emitting module 13a closest to the power feeding side includes nine light-emitting elements 20 in the substrate region E1 including the component mounting region 13e and includes eight light-emitting elements 20 in each of the other substrate regions E2 to E5. Each of the light-emitting modules 13b and 13c located in the middle includes eight light-emitting elements 20 in each of the substrate regions E1 to E6. Further, the light-emitting module 13d most distant from the power feeding side includes nine light-emitting elements 20 in the substrate region E5 most distant from the power feeding side and includes eight light-emitting elements 20 in each of the other substrate regions E1 to E4. In other words, the number of the light-emitting elements 20 mounted in the substrate regions located at both the ends of the lamp 10 is larger than the number of the light-emitting elements 20 in the other substrate regions by one.

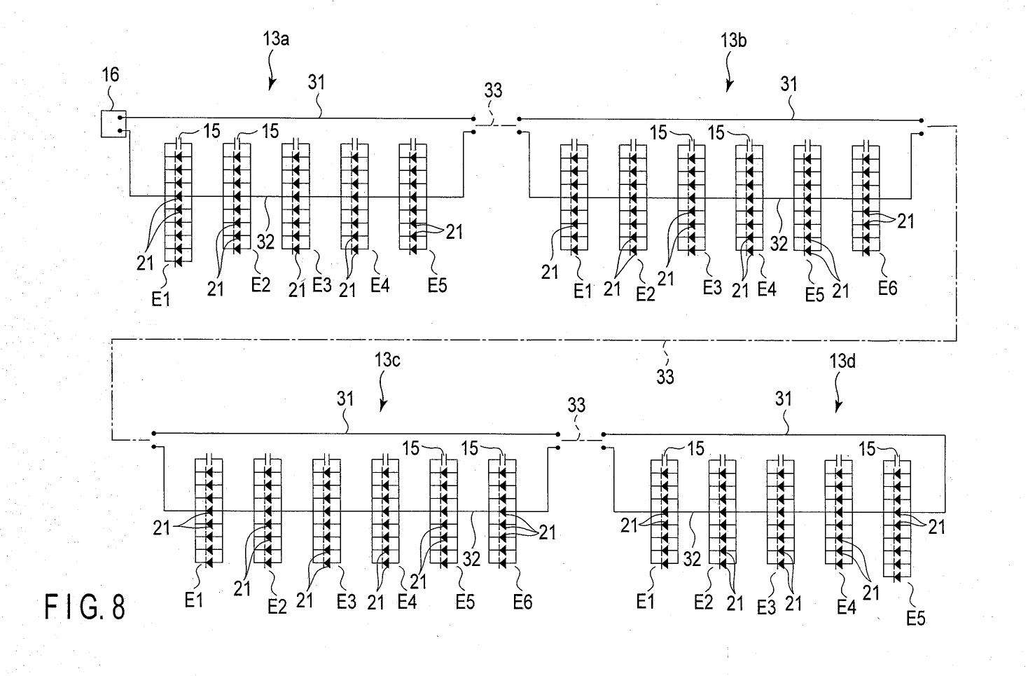

The capacitors 15 scattered along the longitudinal direction of the module array 13 are provided one by one in each of the substrate regions E1 to E5 (E6) of each of the light-emitting modules 13a to 13d. A wiring diagram of the module array 13 is shown in FIG. 8. According to the wiring diagram, each of the capacitors 15 is connected in parallel to a set of LED chips 21 of eight or nine light-emitting elements 20 mounted in each of the substrate regions.

Consequently, each of the capacitors 15 functions as a bypass element of the plural LED chips 21 connected in parallel and prevents noise components superimposed on wiring patterns 31 and 32 explained below from feeding an undesired electric current to the LED chips 21. For example, in a state in which the switch 102 (FIG. 3) of the luminaire 1 is turned off, a noise current is prevented from flowing to the LED chips 21. It is possible to prevent so-called dark lighting of the lamp 10. For example, even if an excess current flows to the wiring patterns 31 and 32 because of some factor, it is possible to prevent a deficiency in which the excess current flows to and destroys the LED chips 21.

Since the eight or nine LED chips 21 in each of the substrate regions E1 to E5 (E6) are connected in parallel, even if one LED chip 21 does not emit light because of an energization failure, it is possible to cause the remaining LED chips 21 to emit light. It is possible to prevent a deficient in which all the LED chips 21 (the light-emitting elements 20) in one substrate region of the lamp 10 are not lit.

In the Component mounting region 13e at the end on the power feeding side of the light-emitting module 13a closest to the power feeding side, an input connector 16, a resistor 17, and a rectifying diode 18 are mounted. The light-emitting elements 20 are not arranged in the component mounting region 13e. Therefore, the electronic components 16 to 18 can be freely laid out in the component mounting region 13e. In this embodiment, the electronic components 16 to 18 are laid out on the center line of the light-emitting module 13a.

Among the electronic components 16 to 18, the resistor 17 and the rectifying diode 18 generate heat according to energization. Therefore, in order to suppress the heat of the electronic components 17 and 18 from being conducted to the light-emitting elements 20 mounted in the substrate region E1, a long hole 19 extending in the width direction of the light-emitting module 13a and piercing through the light-emitting module 13a is provided between the rectifying diode 18 and the light-emitting element 20 closest to the power feeding side. A plurality of the long holes 19 may be provided dividedly in the width direction. The long hole 19 is provided to reduce a sectional area extending along the latitudinal direction of the substrate of the light-emitting module 13a, whereby heat conduction in this portion is suppressed.

As shown in FIG. 8, the input connector 16 is connected to the wiring patterns 31 and 32 of the light-emitting module 13a on the power feeding side. The input connector 16 is connected to the pin 10a of the cap 11a on the power feeding side of the lamp 10. The LED chips 21 of the nine light-emitting elements 20 and the capacitor 15 are connected in parallel halfway in the wiring pattern 32.

Similarly, each of the other light-emitting modules 13b to 13d also has the wiring patterns 31 and 32 for connecting the eight or nine LED chips 21 and the capacitor 15 in parallel. When the four light-emitting modules 13a to 13d are coupled to configure a module array, the wiring patterns 31 and 32 are connected to each other by connector wires 33 among the modules. Consequently, the four light-emitting modules 13a to 13d are also electrically connected. All the light-emitting elements 20 and the capacitors 15 (and the other electronic components 16 to 18) can be supplied with electric power.

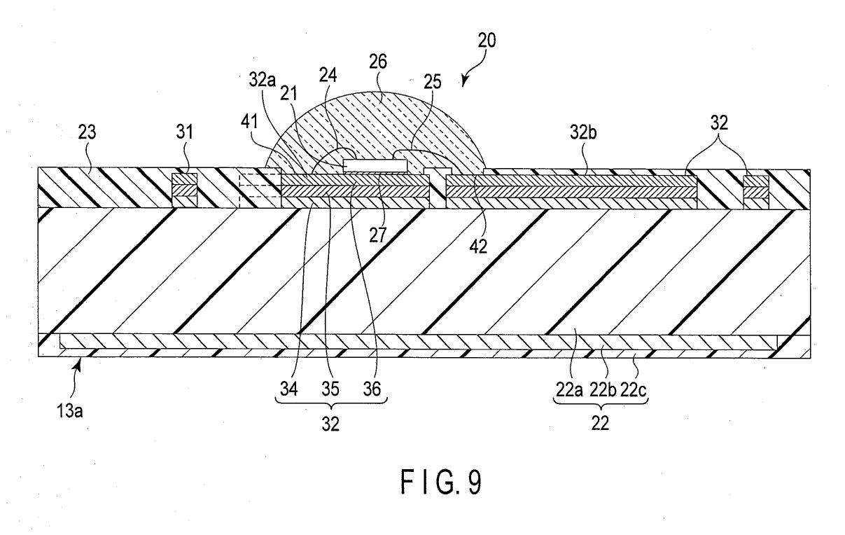

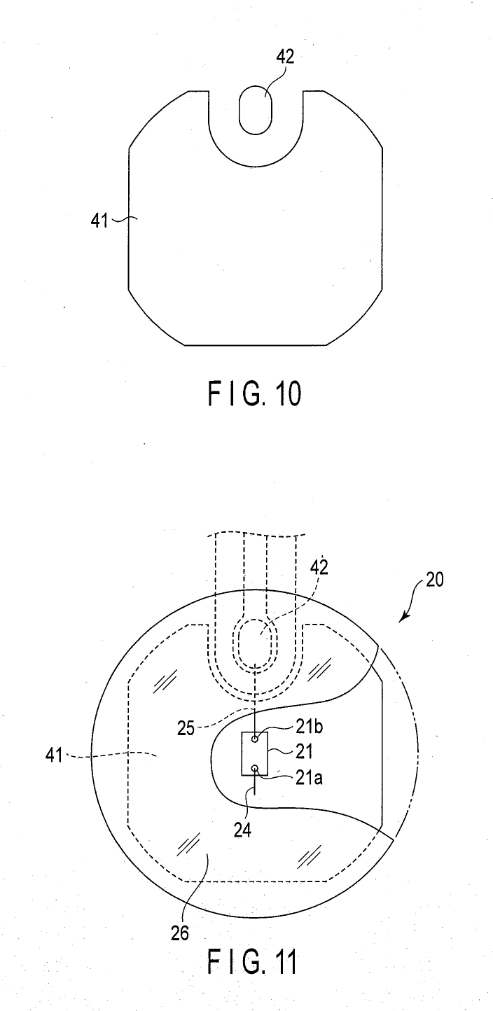

A detailed structure of the light-emitting module 13a and a mounting structure of the light-emitting elements 20 are explained below with reference to FIGS. 9 to 11. Basic structures of the four light-emitting modules 13a, 13b, 13c, and 13d are substantially the same. Therefore, the light-emitting module 13a closest to the power feeding side is representatively explained. FIG. 9 is a sectional view of the light-emitting module 13a taken along a line F9-F9 shown in FIG. 5. FIG. 10 is a plan view of pads 41 and 42, on which the light-emitting element 20 is mounted, viewed from the light extraction side. FIG. 11 is a plan view of a state in which the light-emitting element 20 is provided on the pads 41 and 42 shown in FIG. 10.

As shown in FIG. 9, the light-emitting module 13a includes a band-shaped flat substrate 22 (a module substrate), the wiring patterns 31 and 32, a protective layer 23, the plural LED chips 21, bonding wires 24 and 25, a sealing member 26, and the various electronic components 15, 16, 17, and 18. After being attached on the pad 41 explained below and bonded and connected, the LED chips 21 are sealed on the substrate 22 by the sealing member 26 having translucency.

The substrate 22 has a three-layer structure in which a base layer 22a, a metal layer 22b, and a cover layer 22c are laminated. The base layer 22 having the largest thickness is formed of resin, for example, glass epoxy resin. The base layer 22a formed of the glass epoxy resin has high heat conductivity and is relatively inexpensive. The base layer 22a can be formed of a glass composite material or another synthetic resin material as well.

The metal layer 22b is, for example, a copper foil laminated on the rear surface of the base layer 22a. The metal layer 22b is smaller than the base layer 22a. The periphery of the metal layer 22b does not reach the periphery of the base layer 22a. The cover layer 22c is laminated to cover the peripheral section where the rear surface of the base layer 22a is exposed and the rear surface of the metal layer 22b. The cover layer 22c is a resist layer made of an insulating material, for example, synthetic resin. The substrate 22 is reinforced by the metal layer 22b and the cover layer 22c laminated on the rear surface of the base layer 22a and is prevented from warping.

The wiring patterns 31 and 32 have a three-layer structure in which, for example, a Cu layer 34, a Ni layer 35, and an Ag layer 36 are laminated in order on the front surface of the base layer 22a of the substrate 22 (i.e., the front surface of the substrate 22). In other words, the surfaces of the wiring patterns 31 and 32 are formed of silver. The surfaces function as reflection surfaces that satisfactorily reflect light. The total ray reflectance of the surfaces is equal to or higher than 90%.

The protective layer 23 is, for example, a white resist layer mainly containing electrically insulative synthetic resin. A part of one wiring pattern 32 is exposed from the protective layer 23 to form the pads 41 and 42 shown in FIG. 10. The wiring pattern 32 includes a pattern portion 32a for connecting a plurality of the pads 41 corresponding to the number of light-emitting elements 20 and a pattern portion 32b for connecting the same number of the pads 42. The two pattern portions 32a and 32b are electrically divided from each other. If any one set of the pads 41 and 42 are connected, the pattern portions 32a and 32b are electrically conducted.

The protective layer 23 is provided to cover the most part of the front surface of the substrate 22 excluding the regions of the pads 41 and 42. In other words, the pads 41 and 42 are the exposed surface of the Ag layer, 36 of the wiring pattern 32. Since the protective layer 23 is formed of the white resist, the protective layer 23 functions as a light reflection layer that satisfactorily reflects light. The pads 41 and 42 are provided in a mounting place of the light-emitting element 20 and arranged along the longitudinal direction of the substrate 22.

The LED chip 21 is a bare chip of an LED. For example, a bare chip of a type that emits blue light is used. The bare chip includes a light-emitting layer on one surface of an element substrate made of sapphire and has a rectangular block-like external shape. The LED chip 21 is mounted on the pad 41 by bonding the other surface of the element substrate on the pad 41 using an adhesive 27. On the surface of the light-emitting layer separated from the pad 41, an anode electrode 21a and a cathode electrode 21b are provided to be separated from each other in the longitudinal direction of the LED chip 21.

The anode electrode 21a of the LED chip 21 is connected to the relatively large pad 41, on which the LED chip 21 is mounted, via the bonding wire 24. The cathode electrode 21b is connected to the relatively small pad 42 via the bonding wire 25. In other words, the LED chip 21 is connected to the electrically-separated two pads 41 and 42 using the bonding wires 24 and 25, whereby the pads 41 and 42 can energize the LED chip 21. The bonding wires 24 and 25 are thin lines of metal, for example, thin lines of gold. The bonding wires 24 and 25 are connected using a not-shown bonding machine.

The sealing member 26 is a member obtained by mixing a phosphor and a filler in resin having translucency. The resin of the sealing member 26 has thermoplasticity. It is desirable to use, for example, resin-based silicone resin as the resin. Since the resin-based silicone resin has a three-dimensionally cross-linked composition, the resin-based silicone resin is harder than translucent silicone rubber. The phosphor absorbs blue light and is excited to emit yellow light that is in a complementary color relation with blue.

As shown in FIG. 11, the sealing member 26 is applied to the substrate surface in a larger region that covers the two pads 41 and 42. The sealing member 26 seals the LED chip 21 and the two bonding wires 24 and 25.

When the light-emitting module 13a mounted with the light-emitting elements 20 having the configuration explained above is energized via the wiring patterns 31 and 32, an electric current in a forward direction flows to p-n junction portions of the LED chips 21. Blue light obtained by directly converting electric energy is emitted. The blue light is transmitted through the sealing member 26 and emitted in a light extracting direction. Further, the blue light excites the phosphor mixed in the sealing member 26 to emit light. The yellow light emitted from the phosphor is mixed with the blue light emitted from the LED chips 21 and is emitted as white light.

In the straight tube type lamp 10 and the luminaire 1 according to the embodiment explained above, the plural light-emitting elements 20 are arranged on the imaginary line L′ shifted to one side in the width direction from the center line L of the light-emitting module 13a including the elongated band-shaped substrate. The capacitors 15 are arranged in the positions deviating to the other side in the width direction from the row L′ of the light-emitting elements 20. Therefore, it is possible to reduce the width of the light-emitting module 13a. On the other hand, for example, if it is assumed that the light-emitting elements 20 are arranged on the center line of the substrate having the same width, both spaces on both the sides in the width direction of the light-emitting elements 20 are narrow (the same). There is no mounting space for the capacitors. If the light-emitting element row is provided in the center, the supporting regions by the rails 14a and 14b may be unable to be provided at both the ends in the width direction of the substrates. In other words, since the light-emitting elements 20 are arranged in the positions shifted from the center line L of the substrates, it is possible to reduce the width of the light-emitting module 13a while adopting the supporting structure by the rails 14a and 14b.

As explained above, according to this embodiment, it is possible to reduce the width of the light-emitting modules 13a to 13d (i.e., the module array 13) housed and arranged in the straight tube type lamp 10. Therefore, both the ends in the width direction of the module array 13 can be supported by the two rails 14a and 14b protrudingly provided on the inner surface of the straight tube 12. The assembly of the straight tube type lamp 10 can be facilitated. Furthermore, according to this embodiment, the width of the module substrates can be reduced. Therefore, it is possible to arrange the module array 13 to be displaced to the position shifted to the outer side from the center of the straight tube 12 and realize the wide luminous intensity distribution of the lamp 10.

Since the width of the module substrates is reduced, material costs for the substrate 22 can be reduced, manufacturing costs for the lamp 10 can be reduced, and manufacturing costs for the luminaire 1 can be reduced. Further, since the width of the module substrates is reduced, the light-emitting modules 13a to 13d, i.e., the module array 13 can be reduced in weight. Therefore, it is possible to reduce the weight of the lamp 10 and the weight of the luminaire 1.

In particular, the layout in which the light-emitting elements 20 are shifted from the center as in this embodiment has an effect in the light-emitting modules 13a to 13d of a chip-on-board (COB) type in which the LED chips 21 are mounted on the substrate surface and sealed by the sealing members 26. In other words, the light-emitting elements 20 of the COB type have relatively small mounting height. If tall elements are mounted adjacent to the light-emitting elements 20, shadows are formed by the elements. Therefore, in the light-emitting module of this type, if the other electronic components are mounted side by side in a straight tube in the row of the light-emitting elements 20, undesired shadows tend to be formed in regions where the electronic components are mounted. Therefore, if the light-emitting module including the light-emitting elements 20 of the COB type is used as in this embodiment, it is effective to arrange the capacitors 15 in the positions shifted to the width direction from the rows of the light-emitting elements 20.

The arrangement of the light-emitting elements 20 shifted from the center as in this embodiment has an effect explained below in a manufacturing process for the light-emitting modules 13a to 13d as well.

In general, if a light-emitting module in the past in which a light-emitting element row is not shifted from the center is manufactured, plural substrates are connected in the width direction and electronic components such as light-emitting elements and capacitors are mounted all together. In a mounting process for the electronic components, because of structure, the electronic components may not be able to be attached in a range of a certain fixed distance from the end sides in the width direction of the substrates at both the ends of the plural connected substrates. In other words, in this case, it is necessary to mount the electronic components in positions exceeding the fixed distance from the end sides in the width direction of the substrates. Therefore, it is necessary to increase the width of the substrates. Furthermore, in order to arrange the light-emitting elements along the center of the substrates, it is necessary to provide a substrate region by the same width on the opposite side of the center line as well. It is difficult to reduce the width of the substrates. Therefore, in the past, for example, a method of reducing one substrate, which is used to manufacture a product, providing a dummy substrate at the end in the width direction, and eliminating limitation on mounting positions of the electronic components is adopted.

On the other hand, in the light-emitting modules 13a to 13d in this embodiment, the light-emitting element row is provided in the position displaced to one side in the width direction from the center line L of the substrates. Therefore, it is possible to secure a relatively wide mounting region on the other side in the width direction of the substrates and solve the problem of the mounting positions of the electronic components. In other words, when the electronic components are mounted on the plural substrates connected in the width direction, the electronic components can be mounted from the end side of the substrates on the other side in the width direction where a space is formed because the light-emitting element row is shifted from the center. In this case, it is unnecessary to increase the width of the substrates and provide the dummy substrate.

Therefore, according to this embodiment, a substrate does not need to be discarded in the manufacturing process for the light-emitting module. Therefore, material costs can be reduced.

In the luminaire according to this embodiment, the plural light-emitting elements 20 are mounted side by side on the imaginary line shifted to one side in the width direction from the center line extending along the longitudinal direction of the substrates. Therefore, it is possible to secure, on the other side in the width direction of the substrates, the region where the electronic components are mounted. It is possible to provide a luminaire that is easily assembled and can realize the wide luminous intensity distribution.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the luminaire 1 in which one lamp 10 is attached to the luminaire main body 2 is explained. However, the present invention is not limited to this and may be applied to a luminaire in which two or more lamps are attached to a luminaire main body.

In the embodiment, the luminaire 1 including the straight tube type lamp 10 is explained. However, the present invention is not limited to this and can be applied to a luminaire including a line module without an annular lamp and a pipe structure. In the case of the annular lamp, plural module substrates curved in an arcuate shape are coupled. In this case, for example, the plural light-emitting elements 20 are mounted in positions offset to the curved inner side of the arcuate module substrate. A deficiency due to the offset can be eliminated by an annularly connected state of the light-emitting elements 20. In the luminaire including the line module, a translucent cover provided in a light extracting direction (an emitting direction) functions as an envelope.

In the embodiment, the luminaire including the band-shaped elongated module substrates is explained. However, the present invention is not limited to this. The length of the module substrates may be any length. The module substrates are not limited to the band shape.

Further, in the explanation in the embodiment, the two rails 14a and 14b are used as the pair of supporting sections that support the substrates on the inside of the lamp. However, the present invention is not limited to this. A structure for directly fixing both the end sides of the module substrates, which are along the longitudinal direction of the module substrates, to the inner surface of the straight tube 12 using screws or the like may be adopted. A supporting structure for the substrates may be any structure. Even if the supporting structure is rails, the rails do not always need to be continuous. Plural rails divided along the longitudinal direction of the straight tube 12 may be used.

What is claimed is:

1. A luminaire comprising:
a substrate mounted with a plurality of light-emitting elements in positions shifted to one side in a width direction from a center line extending along a longitudinal direction; and
an envelope provided to cover the substrate.

2. The luminaire according to claim 1, wherein the plurality of light-emitting elements are mounted side by side on the substrate to be parallel to the center line of the substrate.

3. The luminaire according to claim 2, further comprising an electronic component mounted on the other side in the width direction of the substrate.

4. The luminaire according to claim 3, further comprising a pair of supporting sections provided on an inner surface of the envelope and configured to support both end sides of the substrate, which are along the longitudinal direction of the substrate.

5. The luminaire according to claim 4, wherein the envelope is formed by a tubular member including a light transmission section on a light extracting side.

6. The luminaire according to claim 5, wherein the substrate is formed in an elongated rectangular band shape.

7. The luminaire according to claim 6, wherein the pair of supporting sections set a rear surface of the substrate near the inner surface of the envelope separated from the light transmission section and support the substrate in a position shifted from a center of the envelope.

8. The luminaire according to claim 2, wherein the light-emitting element is obtained by sealing, with a material having translucency, an LED chip mounted on the substrate.

9. A luminaire comprising:
an envelope including a light transmission section;
a rectangular substrate provided in the envelope;
a plurality of light-emitting elements mounted side by side in positions shifted to one side in a width direction from a center line extending along a longitudinal direction of one surface of the substrate to be parallel to the center line;
an electronic component mounted on the one surface side of the substrate and in a position shifted to the other side in the width direction of the substrate from positions where the plural light-emitting elements are mounted side by side; and
a pair of supporting sections provided on an inner surface of the envelope and configured to support both end sides of the substrate, which are along the longitudinal direction of the substrate.

10. The luminaire according to claim 9, wherein the light-emitting element is provided on the one surface of the substrate by sealing, with a material having translucency, an LED chip mounted on the one surface.

11. The luminaire according to claim 9, wherein the envelope is a cylindrical elongated straight tube.

12. The luminaire according to claim 11, wherein the substrate is formed in an elongated rectangular band shape.

13. The luminaire according to claim 12, wherein the pair of supporting sections set a surface on an opposite side of the one surface of the substrate near an inner surface of the straight tube and support the substrate in a position shifted from a center of the straight tube.

14. The luminaire according to claim 13, wherein the pair of supporting sections are rails provided on the inner surface of the straight tube along the longitudinal direction.

15. The luminaire according to claim 9, further comprising:
a main body to which the envelope is detachably attached; and
a lighting circuit configured to feed electric power to the substrate.
